(19) United States
(12) Patent Application Publication
(10) Pub. No.: US 2009/0265419 A1
(43) Pub. Date: Oct. 22, 2009

(54) Executing Applications at Servers With Low Energy Costs

(76) Inventors: Steven J. Branda, Rochester, MN (US); Chris D. Johnson, Rochester, MN (US); John J. Stecher, Rochester, MN (US); Matthew R. Weaver, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/104,787

(22) Filed: Apr. 17, 2008

(51) Int. Cl. G06F 15/16

(52) U.S. Cl. 709/203

(57) ABSTRACT

Embodiments of the invention provide methods, systems, and articles of manufacture for managing and executing applications in a clustered server system. In one embodiment, an application may be installed at an application server having the associated lowest energy cost of maintenance, thereby lowering the cost of operating the system. In another embodiment, requests for services from the system may be routed to application servers having the lowest energy cost, thereby lowering the cost of operating the system.

### BACKGROUND OF THE INVENTION

1. Field of the Invention

The present invention is related to data processing systems, and more specifically to tiered server systems.

2. Description of the Related Art

Traditional server systems generally include a single server configured to process requests from multiple clients. Because a single server is used, traditional server systems do not provide safeguards against server failure or an ability to balance workload of the system. Therefore, when a failure occurs in a traditional system, the server becomes unavailable until the failure is resolved and the server is revived. Server failures may occur due to power outages, defective devices, increased workload, and the like. When a failure occurs, any data entered or modified by a client may not be saved. Therefore, the client may have to reenter data that was lost as a result of the server failure. Clustered server systems provide both scalability and safeguards against server failures. A server cluster may include multiple servers that work in conjunction to provide high availability, reliability, and scalability.

### SUMMARY OF THE INVENTION

The present invention is generally related to data processing systems, and more specifically to clustered server systems.

One embodiment of the invention provides a method for executing applications. The method generally comprises receiving a request for executing an application, wherein the request is received by a routing device coupled with a plurality of servers, each of the plurality of servers comprising the application, determining a server, of the plurality of servers, having a cost of energy to operate that is less than a cost of energy for operating at least one remaining server in the plurality of servers, and transferring the request to the determined server.

Another embodiment of the invention provides a computer readable storage medium comprising a program product which, when executed by a processor, is configured to perform an operation for executing applications. The operation generally comprises receiving a request for executing an application, wherein the request is received by a routing device coupled with a plurality of servers, each of the plurality of servers comprising the application, determining a server, of the plurality of servers, having a cost of energy to operate that is less than a cost of energy for operating at least one remaining server in the plurality of servers, and transferring the request to the determined server.

Yet another embodiment of the invention provides a system, generally comprising at least one client computer, a plurality of servers, wherein each application server comprises at least one application, and a routing device coupled with each of the plurality of servers. The routing device is generally configured to receive a request for executing the at least one application, determine a server, of the plurality of servers, having a cost of energy to operate that is less than a cost of energy for operating at least one remaining server in the plurality of servers, and transfer the request to the determined server.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates a detailed view of an exemplary client computer and application server, according to an embodiment of the invention.

FIG. 3 illustrates an exemplary energy costs record according to an embodiment of the invention.

FIG. 4 is a flow diagram of exemplary operations performed to install an application, according to an embodiment of the invention.

FIG. 5 illustrates an exemplary GUI screen to manage applications according to an embodiment of the invention.

FIG. 6 illustrates another exemplary system according to an embodiment of the invention.

### DETAILED DESCRIPTION OF THE PREFERRED EMBODIMENTS

Embodiments of the invention provide methods, systems, and articles of manufacture for managing and executing applications in a clustered server system. In one embodiment, an application may be installed at an application server having the associated lowest energy cost of maintenance, thereby lowering the cost of operating the system. In another embodiment, requests for services from the system may be routed to application servers having the lowest energy cost, thereby lowering the cost of operating the system.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

In conventional client-server systems, applications may be installed on the client computers and servers. The applications on the client computers may be configured to communicate with applications on the servers to receive one or more services over a network. For example, in traditional systems, client computers may have applications containing business logic, while servers may include applications containing data manipulation logic.

However, the increasing popularity of the internet and the growth of electronic commerce and network based business models have shown that the two-tiered client-server architecture is inflexible to meet the growing demand for network based services. For example, the requirement that applications be installed on client computers limits the ability to access critical applications to a physical location of a client computer comprising the requisite applications. Furthermore, making updates to network services requires updating software on all client computers.

One solution may be to implement a multi-tiered clustered client server architecture to obviate the drawbacks of the traditional two-tiered client-server architecture. In a multi-tiered system, one or more applications including application/business logic may be installed on a server, referred to hereinafter as an application server. By moving the applications from a client computer to an application server, client computers may be developed as ‘thin clients’, that is, the clients may only provide a user interface, such as a browser. The applications running on an application server may send instructions and data to the browser for displaying the data to a user using the client computer. The application server may also communicate with one or more backend servers that are configured to manipulate data while providing a service to a ‘thin client.’

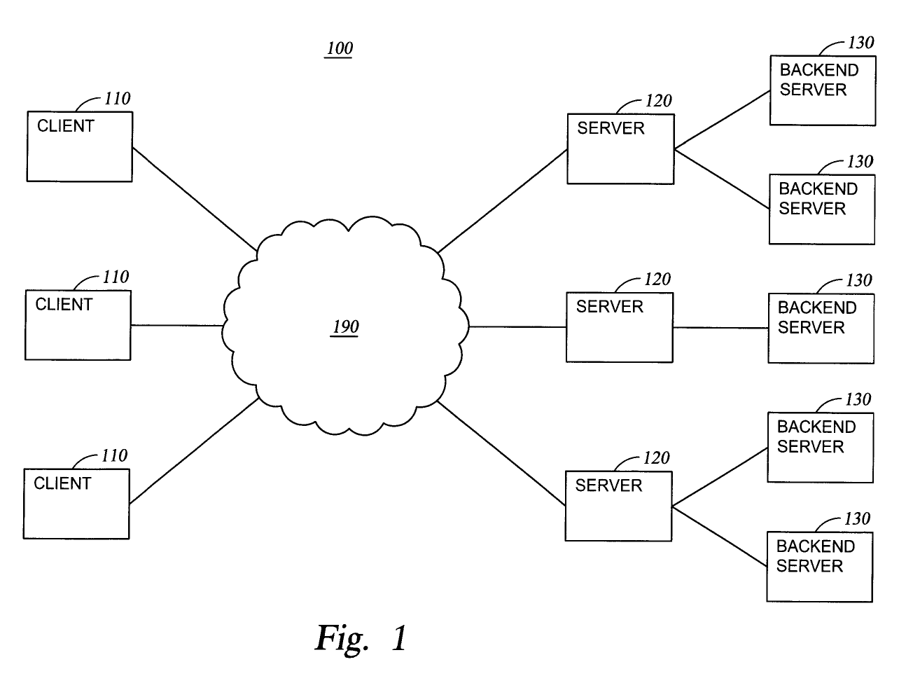

FIG. 1 illustrates an exemplary system 100 according to an embodiment of the invention. As illustrated in FIG. 1, system 100 may include a plurality of client computers 110 and a plurality of application servers 120 connected by a network 190. In one embodiment, each application server 120 may be connected to one or more backend servers 130, as illustrated in FIG. 1. While backend servers 130 are shown connected directly to the application servers 120 in FIG. 1, in alternative embodiments, the backend servers 130 may be connected to the application servers 120 via the network 190. In general, the network 190 may be a local area network (LAN), a metropolitan area network (MAN), a wide area network (WAN), or the like. In a particular embodiment, the network 140 is the Internet.

In one embodiment, the client computer 110 may be a ‘thin client’. Implementing the client computers 110 as thin clients allows new client computers 110 to be easily integrated into the system 100. For example, adding a new client 110 to the system may involve simply including a client computer having a suitable browser program, without concern about installing the correct number and types of applications on the client. Furthermore, implementing the client computer 110 as a thin client allows the rapid development and use of a variety of types of client computers. For example, the client computers may include any one of personal computers, laptop computers, personal digital assistants, mobile phones, and the like, including a suitable browser or minibrowser.

The browsers of a client computer 110 may be configured to request services from one or more applications of an application server 120. In one embodiment of the invention, one or more application servers 120 illustrated in FIG. 1 may be a part of a server cluster. A server cluster may be implemented to provide high accessibility, scalability, and reliability of services provided by the application servers 120. For example, if one of the application servers 120 of a server cluster fails, then one or more other application servers 120 in the cluster may receive and process requests for services from the client computers 110.

In one embodiment, each application server 120 of a cluster may be located at different geographical locations. For example a business organization may have several places of business including locations in Duluth, Minn., and Manhattan, N.Y. To serve clients at both places of business, the business organization may locate a first application server 120 at the Manhattan location and a second application server 120 at the Duluth location. By placing servers 120 in proximity to likely clients or other users of services, long transmission delays over the network 190 may be avoided while providing a service.

Reducing long transmission delays may be especially crucial to time sensitive applications. As an example, the business organization may be an online stock brokerage firm that allows clients to access their respective online stock trading accounts using the Internet. Each client's stock trading account may provide a variety of services to the client including, for example, the ability to trade stocks in a stock exchange market, generate performance reports, receive email alerts for trading, and the like. A contract between the client and the business organization may guarantee instantaneous or near instantaneous trading of desired stocks. Accordingly, it may be crucial for the business organization to avoid communication delays between a client's computer 110 and an application server 120 providing the brokerage services over the network 190. Therefore, a request from a client computer 110 may be serviced by the nearest available application server 120 maintained by the business organization.

While the application servers maintained by the business organization at each location may include substantially the same hardware and software, costs associated with maintaining the servers may vary from location to location. For example, energy costs for maintaining and operating the servers may vary significantly from location to location. Because executing applications on the application server 120 may increase power consumption by the server, in some embodiments, it may be more desirable to perform tasks on servers located where the energy costs are relatively less.

Embodiments of the invention provide methods, systems, and articles of manufacture that facilitate installation of applications in an application server based on a time criticality of the application and the energy costs at locations of application servers in the cluster.

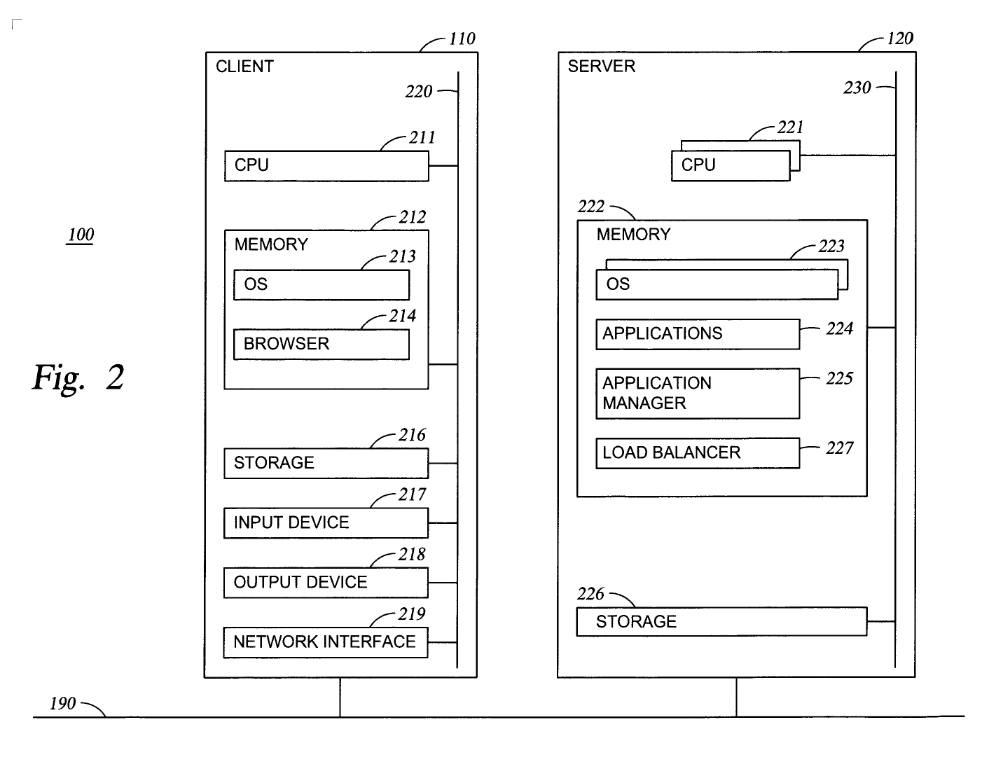

FIG. 2 depicts a more detailed view of the client computer 110 and the application server 120. The client computer 110 may include a Central Processing Unit (CPU) 211 connected via a bus 220 to a memory 212, storage 216, an input device 217, an output device 218, and a network interface device 219. The input device 217 can be any device to give input to the client computer 110. For example, a keyboard, keypad, light-pen, touch-screen, track-ball, or speech recognition unit, audio/video player, and the like could be used.

The output device 218 can be any device to give output to the user, e.g., any conventional display screen. Although shown separately from the input device 217, the output device 218 and input device 217 could be combined. For example, a display screen with an integrated touch-screen, a display with an integrated keyboard, or a speech recognition unit combined with a text speech converter could be used.

The network interface device 219 may be any entry/exit device configured to allow network communications between the client computers 110 and server 120 via the network 190. For example, the network interface device 219 may be a network adapter or other network interface card (NIC).

Storage 216 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 212 and storage 216 could be part of one virtual address space spanning multiple primary and secondary storage devices.

The memory 212 is preferably a random access memory sufficiently large to hold the necessary programming and data structures of the invention. While memory 212 is shown as a single entity, it should be understood that memory 212 may in fact comprise a plurality of modules, and that memory 212 may exist at multiple levels, from high speed registers and caches to lower speed but larger DRAM chips.

Illustratively, the memory 212 contains an operating system 213. Illustrative operating systems, which may be used to advantage, include UNIX, IBM OS/400®, Linux distributions (Linux is a trademark of Linus Torvalds in the US, other countries, or both) and Microsoft's Windows®. More generally, any operating system supporting the functions disclosed herein may be used.

Memory 212 is also shown containing a browser program 214 which, when executed by CPU 211, provides an interface to access applications available at a server 120. In one embodiment, browser program 214 may include a web-based Graphical User Interface (GUI), which allows the user to display Hyper Text Markup Language (HTML) information. In one embodiment, the GUI may be configured to allow a user to create a search string, request search results from an application server 120, and display the search results. In another embodiment, the browser program 214 may display a GUI comprising a web page of a business organization, such as, that of the above mentioned stock brokerage firm. Accordingly, a user at the client computer 110 may be able to log in to and view his/her respective stock trading account, share prices, performance of his portfolio, and the like on a GUI displayed by browser program 214. More generally, however, the browser program 214 may be a GUI-based program capable of rendering any information transferred from an application server 120.

Application server 120 may by physically arranged in a manner similar to the client computer 110. Accordingly, application server 120 is shown generally comprising at least one CPU 221, memory 222, and a storage device 226, coupled with one another by a bus 230. Memory 222 may be a random access memory sufficiently large to hold the necessary programming and data structures that are located on server 120. For example, memory 222 is shown containing at least one operating system 223, applications 224, application manager 225, and a load balancer 227, which will be discussed in greater detail below. The server 120 may generally be under the control of one or more operating systems 223 shown residing in memory 122.

In one embodiment, server 120 may be a logically partitioned system, wherein each logical partition of the system is assigned one or more resources, for example, CPUs 221 and memory 222, available in server 120. Each logical partition of server 120 may be under the control of one of the operating systems 223. Examples of the operating system 223 include IBM OS/400®, UNIX, Linux distributions, Microsoft Windows®, and the like. More generally, any operating system capable of supporting the functions described herein may be used.

The applications 224 may be software products comprising a plurality of instructions that are resident at various times in various memory and storage devices in the computer system 100. When read and executed by one or more processors 221 in the server 120, the applications 224 may cause the system 100 to perform the steps necessary to execute steps or elements embodying the various aspects of the invention. In one embodiment, the applications 224 may include application logic and/or business logic of a business organization. For example, the aforementioned online stock brokerage firm may install applications 224 that facilitate access of online stock trading accounts by their clients.

Load balancer 227 may be configured to route requests for services based on the location of applications in a server cluster. For example, a first application may be installed in a first application server, and a second application may be installed in a second application server. Upon receiving a request from a client computer 110, load balancer 227 may be configured to determine an application associated with the request and route the request to an application server of the cluster containing the application associated with the request. While load balancer 227 is shown as a software component within the application server 220, in alternative embodiments, load balancer may be a standalone hardware device that is configured to route requests for services to particular application servers of a cluster.

In one embodiment, application server 120 may be a web based application server such as, for example, a Hyper Text Transport Protocol (HTTP) server. Accordingly, applications 224 at the server 120 may be configured to receive HTTP requests from a browser program 214 of a client computer 110 and serve the client with HTTP responses comprising data contents, such as, for example, contents to be populated in a web page. An example of a web application server is the WebSphere Application Server, which is a registered trademark of International Business Machines (IBM) Corporation of Armonk, N.Y. The web application server may be configured to receive and process requests for applications and for web content.

In one embodiment, while executing applications 224, application server 120 may be configured to access one or more databases contained in, for example, storage 226. For example, data related to a client's stock trading account, or the contents of a web page may be stored in the storage device 226. Accordingly, applications 224 may be configured to access the storage device 226 in order to respond to requests from a client computer 110. While the storage device 226 is shown as a part of server 120, in alternative embodiments, storage device 226 may be implemented as a standalone external device. In other embodiments, the data required by the applications 224 may be contained in a database server, such as, for example, a backend server 130. Accordingly, the applications 224 may be configured to retrieve the contents from an external storage device 226 or a database server 130 via the network 190.

In one embodiment of the invention, the browser program 214 may represent a client tier of the multi tiered client server architecture. The applications 120 at the web application server may represent a middle, or application server tier, comprising application logic, transaction logic, business logic, and the like. The client tier may include a user interface and graphics control logic for displaying content to a user. For example, the client tier may include the browser program 214 installed on the client computer 110. The client tier may connect to the application server tier via the network 190. The application server tier may include the applications 224 and the application manager 225. The functions of the application manager 225 are described in greater detail below. The application server tier may be configured to implement application logic, transaction logic, business logic, and the like upon receiving requests from the client tier. One or more databases stored in, for example, a storage device 226 or a database server 130 may represent a data storage tier comprising data manipulation logic. The applications in the application server tier may be configured to connect with the data storage tier to retrieve data requested by the client tier.

In one embodiment, the application server tier may be implemented on a Java 2 Platform, Enterprise Edition™ (J2EE). Accordingly, the applications 224 may include servlets, JavaServerPages (JSPs), and/or business logic built into Enterprise JavaBeans (EJBs). Servlets may be java programs that execute in a web container such as a web page. JSPs may provide a method for creating HTML pages. While the application server tier is described herein with reference to Java and J2EE based offerings, embodiments of the invention are not limited to such offerings.

The application server tier may also provide an Application Programming Interface (API) to programmers. The API may be used by programmers to create the applications 224 without being concerned about the particular type of operating system 223 employed at the application server 120, or the huge array of interfaces required of modern web based applications. Providing an API may facilitate rapid development of services provided by the application servers 120.

In some embodiments, the particular applications 224 installed on an application server 120 may depend on a type of service provided by the server. For example, the stock brokerage firm may include a first application server 120 at the Manhattan location. The stock brokerage firm may have a main business office at the Manhattan location where it staffs, for example, its human resources and accounting divisions. Accordingly, applications 224 in the first application server 120 may include applications that are used by the human resources and accounting divisions. The stock brokerage firm may maintain an office that staffs its customer service division at the Duluth location. Accordingly, a second application server 120 may include applications 224 used by the customer service representatives.

Application manager 225 of the application server 120 may be configured to manage the installation of applications 224 at various application servers 120 of an application server cluster. In one embodiment, application manager 225 may be a part of a cluster management system. In a particular embodiment, application manager 225 may be a part of a cluster management system for managing a plurality of Websphere Application Servers. In one embodiment, the application manager 225 may receive a new application for installation in the application server cluster and install the application in a particular application server 120 of the cluster. In one embodiment, the particular application server 120 at which the application is installed may be determined based on a type of the application.

For example, in one embodiment, if the application is determined to be a time critical application, the application may be installed at an application server 120 that is closest to client computers likely to use the application. Therefore, transmission delays while using the application may be minimized. The particular application server at which a time critical application is installed may be identified by a network manager or other person having authority the designate the location of the application. In an alternate embodiment, the installation of applications may be determined based on the energy costs at the various application servers 120 of the cluster.

In one embodiment, when a new application 224 is developed, a programmer, network administrator, manager, or other person having authority may designate the application as a moveable application. Moveable applications may be applications that are not time critical. In other words, the long transmission delays during execution of the applications may be acceptable.

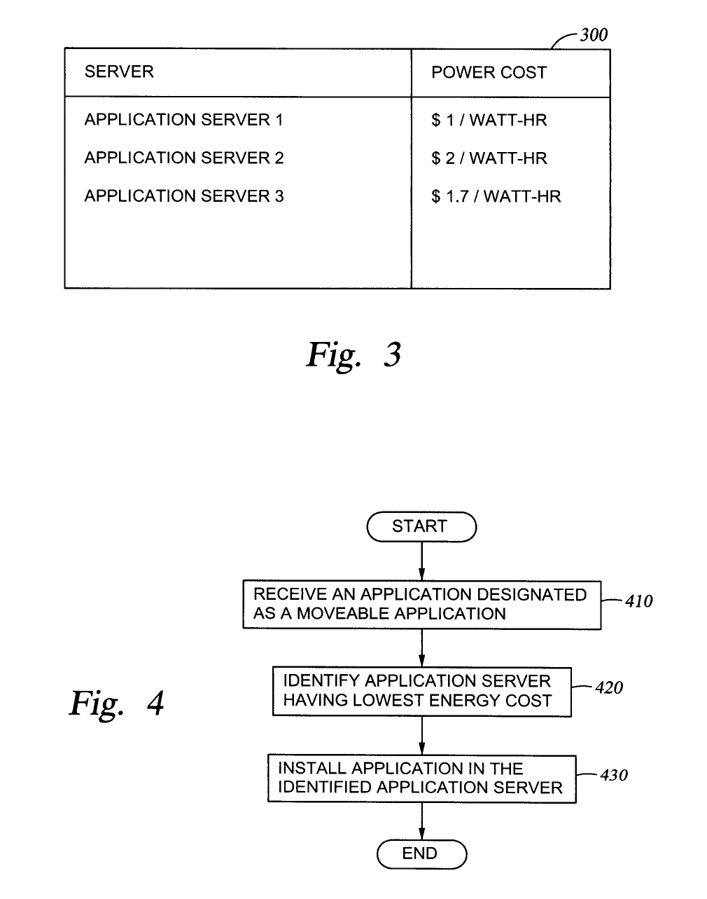

In one embodiment, when an application manager 225 receives a moveable application for installation, the application manager 225 may identify an application server 120 that has minimum power consumption costs. For example, in one embodiment, the application server 120 may include a record containing power costs for each of the application servers 120 in a respective cluster. FIG. 3 illustrates an exemplary record 300 containing power costs for application server 120 of a cluster.

In one embodiment, as illustrated in FIG. 3, the record 300 may include a cost per Watt-hour of power consumed by each application server 120 of the cluster. While a cost per Watt-hour is illustrated herein, any other reasonable measure for determining energy costs, for example, cost per BTU, may be used to represent energy costs. The record 300 may be maintained at a suitable storage location, for example, in the memory 222, storage 226 of the application server, or in a backend server 130.

Upon receiving a moveable application for installation, the application manager 225 may be configured to identify an application server having the lowest energy cost in the record 300, which would be Application Server 1 in the example illustrated in FIG. 3. Upon identifying the application server having the lowest cost, the application manager 225 may install the moveable application at the identified application server.

In one embodiment, the application manager 225 may be configured to periodically update the record 300 by retrieving the most recent energy costs from, for example, a power company providing energy at the locations of each application server 120 of the cluster. For example, in one embodiment, the application manager 225 may be configured access a server maintained by the power company via the network 190 and retrieve the most recent energy cost contained therein. Alternatively, one or more power companies may be able to access and update the record 300 via the network 190. In still other embodiments, the power costs may be input manually into the record 300.

Application manager 225 may update the record 300 at any reasonable frequency. For example, in one embodiment, application manager 225 may update the record 300 upon receiving a request for use of an application, thereby allowing the application manager to determine the most energy cost efficient server in real time. In alternative embodiments, application manager may be configured to update the record 300 after a predetermined period of time. For example, in one embodiment, because energy costs remain relatively stable in a particular season, application manager 225 may be configured to update the record 300 at the beginning of a new season. In one embodiment, the application manager 225 may be configured to monitor an energy index to identify substantial changes in energy prices. If a substantial change in energy prices is detected, application manager 225 may update the record 300, in response to the substantial change.

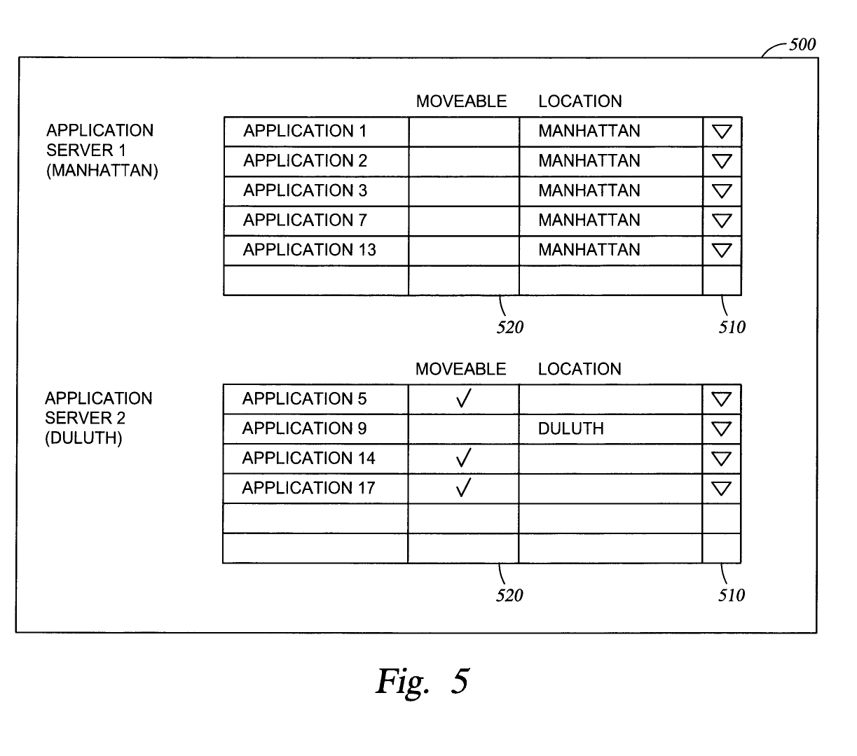

FIG. 4 is a flow diagram of exemplary operations performed by the application manager 225 while installing an application. The operations may begin in step 410 by receiving an application that is designated as a moveable application. In step 420, the application manager 225 may identify an application server of the cluster having the lowest energy cost. Thereafter, in step 430, the application manager 225 may install the application at the identified application server.

In one embodiment, application manager 225 of the application server 120 may keep track of all the applications being used in a cluster of application servers. For example, the application manager 225 may maintain a record in a storage location, for example, in memory 222, storage device 226, or the like, wherein the record contains locations where each application is installed and/or whether the application is designated as a moveable application.

In some embodiments, application manager 225 may be configured to display the record in a browser program 214. FIG. 5 illustrates an exemplary GUI screen 500 displayed by an application manager 225 at a client computer 110. The client computer 110 may be, for example, a computer operated by a network administrator. As illustrated in FIG. 5, the GUI 500 may display applications installed at each application server 120 of a cluster. For example applications 1, 2, 3, 7, and 13 are shown in FIG. 5 as being installed at Application Server 1 in Manhattan. Also shown in FIG. 5, are applications 5, 9, 14, and 17, installed at Application Server 2 in Duluth.

In one embodiment, GUI screen 500 may include a graphical tool 510 to facilitate selection of a location at which a particular application should be installed. For example, a drop down menu 510 may be provided for each application to specify a location at which the application is to be installed. If a network administrator, or other authorized person, wishes to change the location at which a particular application is installed, the network administrator may select a desired location from the dropdown menu 510 associated with the particular application. In one embodiment, application manager 225 may receive selections made in the graphical tool 510 and install applications at indicated locations in response to receiving the selections.

In some embodiments, GUI screen 500 may include a graphical tool 520 to indicate whether an application is moveable. The graphical tool is shown as checkboxes 520 in FIG. 5. A network administrator, or other authorized person, may click a checkbox 520 associated with a particular application to designate the application as a moveable application. In one embodiment, application manager 225 may receive the selections made in the graphical tool 520 and install applications at an application server where energy costs are minimized. For example, the application manager 225 may perform the steps illustrated in FIG. 4 to install the applications based on the selections made in the graphical tool 520. In one embodiment, installing the application at an application server where energy costs are minimized may include uninstalling the application from a first server in which the application is installed and installing the application in a second server, wherein the energy cost for operating the first server is greater than the energy cost for operating the second server.

While a dropdown menu 510 and check boxes 520 are illustrated in FIG. 5, in alternative embodiments, any reasonable type of graphical tool, for example, text boxes, radio buttons, icons, buttons, and the like may be used to receive selections indicating either a location for installing applications, or whether applications are moveable.

In one embodiment of the invention, if an application is designated as moveable, a user may be prevented from selecting a location to install the application using the graphical tool 510. For example, the drop down menu for application 5 may be disabled because application 5 is designated as a moveable application. However, if the check box 520 for application 5 is deselected, the drop down menu 510 for application 5 may become enabled, thereby allowing selection of a location for installation. In other embodiments of the invention, if a selection is made in the graphical tool 510, the graphical tool 520 for a respective application may be disabled. For example, the checkboxes 520 for applications 1 and 2 may be disabled because the graphical tool 510 includes a selection of a location for installation.

In one embodiment of the invention, applications received for installation may be designated as moveable by default. For example, if a selection is not received in either of graphical tools 510 and 520, the application may be deemed to be a moveable application by the application manager 225, and installed accordingly at a location when energy costs are lower.

In some embodiments, limits may be placed on the number and/or types of applications that may be installed in a particular application server of the server cluster. Therefore, in some embodiments, if an application limit is reached for one of the application servers, application manager 225 may be configured to select another application server in the cluster on which the application may be installed. For example, each application server of the cluster may have a limit of 5 installed applications. If the server having the least associated energy cost contains 5 installed applications, application manager 225 may select a next least expensive server on which to install moveable applications.

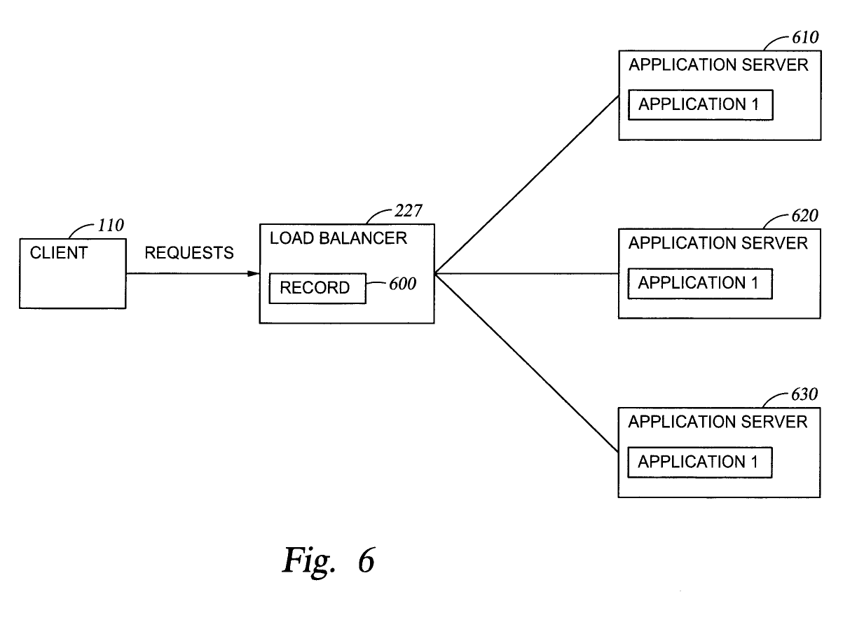

In one embodiment of the invention, each application may be installed in one or more of the application servers 120 of a server cluster. A load balancer 227 may be configured to route requests for an application to an application server of the cluster based on a type of the application and/or an energy cost for processing the request. FIG. 6 illustrates an exemplary system in which each application is installed in one or more application servers. Specifically, an application, application 1, is shown installed on each of application servers 610-630. A client computer 110 and a load balancer 227 are also illustrated in FIG. 6. For the purposes of this example, application server 610 is assumed to have the lowest energy costs and application server 630 is assumed to have the smallest transmission delay while processing requests from client computer 110.

The load balancer 227 may be configured to route requests for services associated with application 1 to one of application servers 610-630 based on a type of the application. The type of the application may be stored in a record 600 in the load balancer 227. The record 600 may be modified using, for example, the GUI screen 500 illustrated in FIG. 5. In one embodiment, the record 600 may also include energy cost data such as, for example, the energy cost data illustrated in record 300 of FIG. 3.

Exemplary types for the application may include, for example, moveable, time critical, and the like. In one embodiment, if application 1 is designated as a moveable application, load balancer 610 may be configured to route requests associated with application 1 to application server 610 because application server 610 has the lowest energy cost. For example, the load balancer 227 may be configured to determine the energy costs at the application servers 610, identify the application server with the lowest energy cost, and route requests to the identified application server.

If application 1 is determined to be a time critical application, load balancer 227 may be configured to route the request to application server 630, because application server 630 has the smallest transmission delays. In one embodiment, if neither of application servers 610 and 630 are unavailable due to, for example, a server failure, requests associated with application 1 may be routed to application server 620.

While routing of requests based on application type is discussed herein, in alternative embodiments, any other criteria may also be used to route the requests. In one embodiment, the routing of requests may be based on a type of the user requesting a service from application 1. For example, in one embodiment, a user may be characterized into one or more classifications such as an “elite” user or “platinum” user. Requests from such “elite” users may be processed in a time critical manner. For example, the request may be routed to an application server that has lowest transmission delays. Accordingly, load balancer 227 may be configured to identify a user type based on a request prior to routing the request. Requests from users that are not classified as “elite” users may be services in a manner that conserves energy, for example, by routing the request to the lowest cost application server.

In one embodiment of the invention, the load balancer 227 may be configured to regulate traffic of requests to the application servers 610-630. For example, if application 1 is a moveable application and a large number of requests for application 1 are received, processing the large number of requests may result in a unacceptably long delays, or even a failure at the application server 610. To prevent server failures, unacceptably long delays, and like conditions, the load balancer may be configured to route at least some of the large number of requests for application 1 to an alternative application server, for example, application server 620.

In a particular embodiment, the load balancer may be configured to route only a threshold number of requests to an application server at any given time. If a threshold number of requests are received and transferred to a given application server, the load balancer 227 may be configured to route subsequent requests to an alternative server until processing of at least some of the threshold number of requests is completed at the given server. Alternatively, the load balancer 227 may be configured to send an error message to requesting devices when the threshold number of requests are received.

In one embodiment of the invention, the load balancer 227 may be configured to monitor and analyze cost trends of the application servers 610-630 and route requests to the application servers based on the cost trends. For example, in one embodiment, if application server 610 is determined to be the lowest cost server, but the trends analysis determines that the application server will be the lowest cost server for a relatively short period of time, the load balancer 227 may not route the requests to the application server 610. Rather, the load balancer 227 may route the requests to an application that is expected to have a more stable low cost.

The routing of requests based on cost trends may be performed to avoid a high frequency of switching between the servers while processing requests. A high frequency of switching between servers may be undesirable because it may lead to a high cost associated with frequently reviving servers from stand-by mode each time the server is selected for processing requests.

By allowing applications to be installed and executed at locations where the energy costs are lower, embodiments of the invention may costs associated with maintaining and operating server clusters. Additionally and/or alternatively, requests for services may be routed for processing to destinations selected on the basis of energy costs for performing a service.

While embodiments are described herein with respect to a client/server model, this model is merely used for purposes of illustration. Persons skilled in the art will recognize other communication paradigms, all of which are contemplated as embodiments of the present invention. As such, the terms “client” and “server” are not to be taken as limiting.

While the foregoing is directed to embodiments of the present invention, other and further embodiments of the invention may be devised without departing from the basic scope thereof, and the scope thereof is determined by the claims that follow.

What is claimed is:

1. A method for executing applications, comprising:
receiving a request for executing an application, wherein the request is received by a routing device coupled with a plurality of servers, each of the plurality of servers comprising the application;
determining a server, of the plurality of servers, having a cost of energy to operate that is less than a cost of energy for operating at least one remaining server in the plurality of servers; and
transferring the request to the determined server.

2. The method of claim 1, further comprising, prior to determining the server, determining whether the application is designated as an application capable of being executed with a lowest energy cost.

3. The method of claim 2, further comprising, prior to determining the server, determining a user type of a user sending the request, wherein the user type indicates whether requests associated with the user are to be processed at a lowest energy cost.

4. The method of claim 1, wherein determining the server comprises accessing a record comprising a cost of energy associated with each of the plurality of servers.

5. The method of claim 1, wherein each of the plurality of servers are located at different geographic locations.

6. The method of claim 1, wherein each of the plurality of servers are application servers.

7. The method of claim 1, further comprising determining whether a threshold number of requests for executing the application have been received at the determined server, and upon determining that a threshold number of requests have been received, transferring the request for executing the application to a server having a cost of energy to operate that is greater than the determined server.

8. A computer readable storage medium comprising a program product which, when executed by a processor, is configured to perform an operation for executing applications, the operation comprising:
receiving a request for executing an application, wherein the request is received by a routing device coupled with a plurality of servers, each of the plurality of servers comprising the application;
determining a server, of the plurality of servers, having a cost of energy to operate that is less than a cost of energy for operating at least one remaining server in the plurality of servers; and
transferring the request to the determined server.

9. The method of claim 8, the operation further comprising, prior to determining the server, determining whether the application is designated as an application capable of being executed with a lowest energy cost.

10. The method of claim 8, the operation further comprising, prior to determining the server, determining a user type of a user sending the request, wherein the user type indicates whether requests associated with the user are to be processed at a lowest cost.

11. The method of claim 8, wherein determining the server comprises accessing a record comprising a cost of energy associated with each of the plurality of servers.

12. The method of claim 8, wherein each of the plurality of servers are located at different geographic locations.

13. The method of claim 8, wherein each of the plurality of servers are application servers.

14. The method of claim 8, the operation further comprising determining whether a threshold number of requests for executing the application have been received at the determined server, and upon determining that a threshold number of requests have been received, transferring the request for executing the application to a server having a cost of energy to operate that is greater than the determined server.

15. A system, comprising:
at least one client computer;
a plurality of servers, wherein each application server comprises at least one application; and
a routing device coupled with each of the plurality of servers, wherein the routing device is configured to:
receive a request for executing the at least one application;
determine a server, of the plurality of servers, having a cost of energy to operate that is less than a cost of energy for operating at least one remaining server in the plurality of servers; and
transfer the request to the determined server.

16. The system of claim 15, wherein the routing device is configured to determine the server by determining whether the application is designated as an application capable of being executed with a lowest energy cost.

17. The system of claim 15, wherein the routing device is configured to determine the server by determining a user type of a user sending the request, wherein the user type indicates whether requests associated with the user are to be processed at a lowest cost.

18. The system of claim 15, wherein the routing device is configured to determine the server by accessing a record comprising a cost of energy associated with each of the plurality of servers.

19. The system of claim 15, wherein each of the plurality of servers are located at different geographic locations.

20. The system of claim 15, wherein each of the plurality of servers are application servers.

21. The system of claim 15, wherein the routing device if further configured to determine whether a threshold number of requests for executing the at least one application have been received at the determined server, and upon determining that a threshold number of requests have been received, transfer the request for executing the application to a server having a cost of energy to operate that is greater than the determined server.
